(19) United States
(12) Patent Application Publication
(10) Pub. No.: US 2025/0058394 A1
(43) Pub. Date: Feb. 20, 2025

(54) ARC ADDITIVE APPARATUS AND METHOD AND STORAGE MEDIUM

(71) Applicant: WUYI UNIVERSITY, Jiangmen (CN)

(72) Inventors: Ruichao WANG, Jiangmen (CN); Hao WANG, Jiangmen (CN); Xiang GAO, Jiangmen (CN); Chuanqi CAI, Jiangmen (CN); Huijun LI, Jiangmen (CN)

(21) Appl. No.: 18/724,855

(22) PCT Filed: Jun. 15, 2022
(86) PCT No.: PCT/CN2022/098986

§ 371 Date: Jun. 27, 2024

(30) Foreign Application Priority Data
May 23, 2022 (CN) 2022105602863

(51) Int. Cl. B23K 9/04; B23K 9/173; B23K 9/32; B33Y 10/00; B33Y 30/00; B33Y 40/00

(52) U.S. Cl. CPC B23K 9/04; B23K 9/173; B23K 9/32; B33Y 10/00; B33Y 30/00; B33Y 40/00

(57) ABSTRACT

An arc additive apparatus and method, and a storage medium are disclosed. The arc additive apparatus includes: an additive welding gun, configured for melting a wire to perform additive manufacturing on a workpiece to be machined; a bypass ultrasonic device, arranged at a side of the additive welding gun; a bottom ultrasonic device, arranged below the workpiece; and a control device, configured for controlling the bypass ultrasonic device to emit ultrasonic waves below the additive welding gun so as to adjust a frequency of droplet transfer of the wire and controlling the bottom ultrasonic device to perform ultrasonic impact on the molten wire on the workpiece.

### CROSS-REFERENCE TO RELATED APPLICATIONS

This application is a national stage filing under 35 U.S.C. § 371 of international application number PCT/CN2022/098986, filed Jun. 15, 2022, which claims priority to Chinese patent application No. 202210560286.3 filed May 23, 2022. The contents of these applications are incorporated herein by reference in their entirety.

### TECHNICAL FIELD

The present disclosure relates to the field of additive manufacturing, and in particular, to arc additive apparatus and method, and a storage medium.

### BACKGROUND

Additive manufacturing technology is a revolutionary manufacturing technology that overturns traditional subtractive manufacturing methods. In particular, metal additive manufacturing, as a revolutionary and advanced manufacturing technology, is widely applied in fields such as aerospace, biomedical, industrial molds, and power energy. As one of the additive manufacturing technologies, the arc additive manufacturing technology involves melting a wire through an arc, and stacking the molten metal layer by layer according to a three-dimensional model of a product, to form a metal part after solidifying. However, there are also some problems in the arc additive process that the quality of the molded surface is relatively rough and the residual stress of the molded workpiece is large, which affects the molding quality and mechanical properties of the workpiece.

### SUMMARY

The present disclosure aims to at least solve one of the technical problems in the existing technology. To this end, the present disclosure proposes an arc additive apparatus and method, and a storage medium, which can improve the mechanical properties of a weld, and enhance the quality of a workpiece.

In a first aspect, the present disclosure provides an arc additive apparatus, including:
an additive welding gun, configured for melting a wire to perform additive manufacturing on a workpiece to be machined;
a bypass ultrasonic device, arranged at a side of the additive welding gun;
a bottom ultrasonic device, arranged below the workpiece; and
a control device, configured for controlling the bypass ultrasonic device to emit ultrasonic waves below the additive welding gun so as to adjust a frequency of droplet transfer of the wire and controlling the bottom ultrasonic device to perform ultrasonic impact on the molten wire on the workpiece.

The arc additive apparatus provided according to the first aspect of the present disclosure has at least the following beneficial effects. The arc additive apparatus includes the additive welding gun, the bypass ultrasonic device, the bottom ultrasonic device, and the control device. The additive welding gun is configured for melting the wire to perform additive manufacturing on the workpiece to be machined, and the wire is melted to form the molten pool. In the additive process, the welding gun moves in the welding direction, and the bottom ultrasonic device performs ultrasonic impact on the molten wire. The ultrasonic impact will stir the molten pool, thereby eliminating bubbles in the molten pool. In addition, the bypass ultrasonic device regulates droplet transfer of the wire to ensure the stability in the additive welding process, thereby improving the additive efficiency and additive quality, and part of the ultrasonic waves emitted by the bypass ultrasonic device enters the molten pool and the bypass ultrasonic device cooperates with the bottom ultrasonic device to optimize the workpiece in the additive process, so as to eliminate the bubbles in the molten pool. Furthermore, large grains in the solidification process of the molten pool are broken and the weld grains are continuously refined, thereby improving the mechanical properties of the weld and enhancing the quality of the workpiece.

According to some embodiments of the present disclosure, the bypass ultrasonic device includes a bypass ultrasonic generator, a first ultrasonic transducer, and a second ultrasonic transducer, the first ultrasonic transducer and the second ultrasonic transducer are arranged on opposite sides of the additive welding gun, a signal transmitting end of the bypass ultrasonic generator is connected to the first ultrasonic transducer and the second ultrasonic transducer, and the bypass ultrasonic generator is electrically connected to the control device.

According to some embodiments of the present disclosure, the bypass ultrasonic device further includes a first amplitude transformer and a second amplitude transformer, a receiving end of the first amplitude transformer is connected to a transmitting end of the first ultrasonic transducer, a receiving end of the second amplitude transformer is connected to a transmitting end of the second ultrasonic transducer, and transmitting ends of the first amplitude transformer and the second amplitude transformer are both concave arc surfaces.

According to some embodiments of the present disclosure, the first ultrasonic transducer and the second ultrasonic transducer are both fixedly connected to the additive welding gun.

According to some embodiments of the present disclosure, the bottom ultrasonic device includes a bottom ultrasonic generator and at least one third ultrasonic transducer, the third ultrasonic transducer is arranged below the workpiece and configured for generating an ultrasonic field covering the workpiece, a signal transmitting end of the bottom ultrasonic generator is connected to the third ultrasonic transducer, and the bottom ultrasonic generator is electrically connected to the control device.

According to some embodiments of the present disclosure, the arc additive apparatus further includes a welding machine and a wire feeder, one end of the wire feeder is connected to the additive welding gun through a pipeline, the wire feeder is configured for transferring the wire to the additive welding gun through the pipeline, the wire feeder is connected to the welding machine, and the welding machine is electrically connected to the control device.

According to some embodiments of the present disclosure, the arc additive apparatus further includes a containing device for providing inert gas, the containing device is in communication with the additive welding gun.

According to some embodiments of the present disclosure, a frequency range of the ultrasonic waves emitted by the bypass ultrasonic device is 20 kilohertz to 50 kilohertz, and a frequency range of ultrasonic waves emitted by the bottom ultrasonic device is 18 kilohertz to 23 kilohertz.

In a second aspect, the present disclosure provides an arc additive method, applied to an arc additive apparatus. The arc additive apparatus includes an additive welding gun, a bypass ultrasonic device, and a bottom ultrasonic device, the bypass ultrasonic device is arranged at a side of the additive welding gun, the bottom ultrasonic device is arranged below the workpiece, and the arc additive method includes:
acquiring an additive instruction;
according to the additive instruction, controlling the additive welding gun to melt a wire and form a molten pool below the additive welding gun;
moving the additive welding gun according to a welding position to be added on the workpiece to be machined;
in a welding process of the additive welding gun, controlling the bypass ultrasonic device to emit ultrasonic waves below the additive welding gun so as to adjust a frequency of droplet transfer of the wire; and
in the welding process of the additive welding gun, controlling the bottom ultrasonic device to perform ultrasonic impact on the molten wire on the workpiece.

Since the arc additive method in the second aspect is applied to the arc additive apparatus described in any embodiment in the first aspect, the arc additive method has all the beneficial effects of the first aspect of the present disclosure.

In a third aspect, the present disclosure provides a computer storage medium, including computer-executable instructions stored therein, the computer-executable instructions are used to execute the arc additive method according to the first aspect of the present disclosure.

Since the computer storage medium in the third aspect can perform the arc additive method in the second aspect, the computer storage medium has all the beneficial effects of the first aspect of the present disclosure.

Additional aspects and advantages of the present disclosure will be set forth in part in the description which follows, and in part will be apparent from the description, or may be learned by practice of the present disclosure.

### BRIEF DESCRIPTION OF DRAWINGS

In order to more clearly illustrate the technical solutions in the embodiments of the present disclosure, the drawings needed to be used in the description of the embodiments or related art will be briefly introduced below. Apparently, the drawings in the following description are only some embodiments of the present disclosure. Those of ordinary skill in the art can also obtain other drawings based on these drawings without making creative efforts.

FIG. 1 is a structural block diagram of arc additive apparatus provided in an embodiment of the present disclosure;

FIG. 2 is a schematic structural diagram of the arc additive apparatus provided in an embodiment of the present disclosure; and

FIG. 3 is a flowchart of the main steps of the arc additive apparatus provided in an embodiment of the present disclosure.

Reference numerals: arc additive apparatus 100; additive welding gun 110; bypass ultrasound device 120; bypass ultrasonic generator 121; first ultrasonic transducer 122; second ultrasonic transducer 123; first amplitude transformer 124; second amplitude transformer 125; bottom ultrasonic device 130; bottom ultrasonic generator 131; third ultrasonic transducer 132; control device 140; workpiece 150; welding machine 151; wire feeder 152; containing device 153; and substrate 154.

### DETAILED DESCRIPTION

In the following description, for the purpose of explanation rather than limitation, specific details such as specific system structures and technologies are provided to provide a thorough understanding of the embodiments of the present disclosure. However, it will be apparent to those of ordinary skills in the art that the embodiments of the present disclosure may also be implemented in other embodiments without these specific details. In other instances, detailed descriptions of well-known systems, devices, circuits, and methods are omitted so as not to obscure the description of the embodiments of the present disclosure with unnecessary details.

It should be noted that although a logical sequence is shown in the flowchart, in some cases, the steps shown or described may be performed in an order different from that in the flowchart. The terms “first”, “second”, etc. in the description, claims, and above drawings are used to distinguish similar objects and are not necessarily used to describe a specific sequence or precedence order.

It should also be understood that reference to “an embodiment” or “some embodiments” or the like in the description of the embodiments of the present disclosure means that the specific features, structures or characteristics described in connection with the embodiment(s) are included in one or more of the embodiments of the present disclosure. Therefore, the phrases “in an embodiment”, “in some embodiments”, “in other embodiments”, “in other embodiments”, etc. appearing in different places in this specification do not necessarily refer to the same embodiment, but refer to “one or more but not all embodiments” unless specifically stated otherwise. The terms “including/comprising”, “containing” “having”, and variations thereof all mean “including but not limited to” unless otherwise specifically emphasized.

In the description of the present disclosure, greater than, less than, more than, etc. are understood to exclude the specified number, and above, below, within, etc. are understood to include the specified number. If described, first and second are only for the purpose of distinguishing technical features, and cannot be understood as indicating or implying the relative importance or implicitly indicating the number of indicated technical features or implicitly indicating the precedence order of indicated technical features. It should be understood that the orientation or positional relationships related to orientation descriptions, such as up, down, front, back, left, right, etc. are based on the orientation or positional relationships shown in the drawings, and are only for ease of describing the present disclosure and simplifying the description, rather than indicating or implying that the device or element referred to must have a specific orientation, be constructed and operate in a specific orientation, and therefore cannot be construed as a limitation on the present disclosure.

Additive manufacturing technology is a revolutionary manufacturing technology that overturns traditional subtractive manufacturing methods. In particular, metal additive manufacturing, as a revolutionary and advanced manufacturing technology, is widely applied in fields such as aerospace, biomedical, industrial molds, and power energy. At present, the metal additive technology is mainly divided into laser additive and arc additive. Laser additive has the advantages of good molding effect and high precision and the like, but it produces smaller workpieces and has slower molding speed, making it suitable primarily for manufacturing more precise workpieces. The arc additive manufacturing technology is a process in which the wire is melted by an arc, and the molten metal is stacked layer by layer according to the three-dimensional model of the product, and solidified to form the metal part. The arc additive manufacturing technology can realize the manufacturing of large-sized workpieces, and its manufacturing speed is much faster than that of laser additive manufacturing. However, the manufacturing apparatus used in arc additive manufacturing technology has low precision, resulting in large surface roughness of the parts. Additionally, the heat input in the manufacturing process is high, leading to significant processing stress in the products and making them prone to cracking and other defects.

On this basis, embodiments of the present disclosure provide an arc additive apparatus and method, and a storage medium. The arc additive apparatus provided in the embodiments of the present disclosure adds a corresponding ultrasonic field to the additive process through an additional ultrasonic generating device, thereby achieving improvements in the additive process.

The embodiments of the present disclosure will be further described below with reference to the drawings.

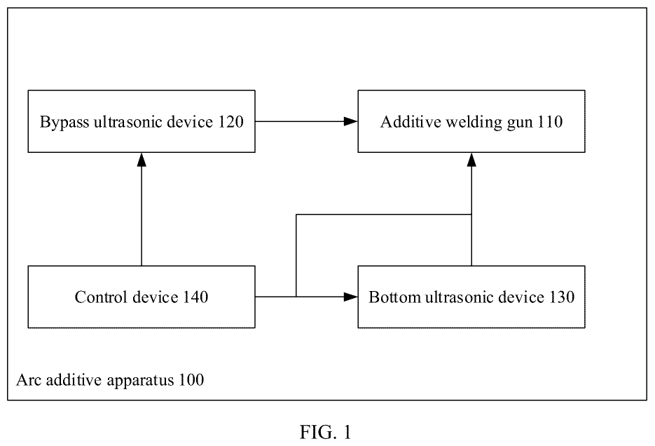

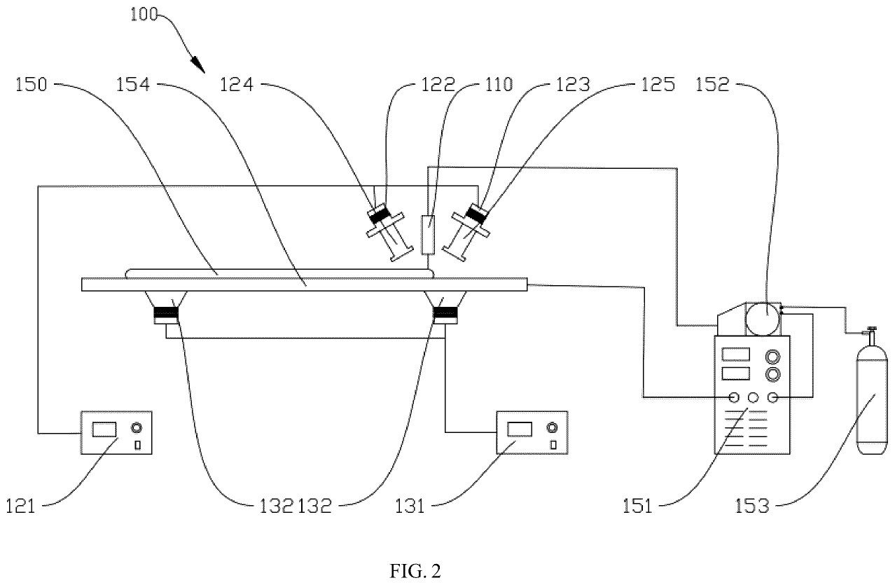

Referring to FIGS. 1 and 2, the arc additive apparatus 100 provided in an embodiment of the present disclosure includes an additive welding gun 110, a bypass ultrasonic device 120, a bottom ultrasonic device 130, and a control device 140. The control device 140 is connected to the additive welding gun 110, the bypass ultrasonic device, and the bottom ultrasonic device 130, respectively. The additive welding gun 110 is configured for melting a wire for additive manufacturing of a workpiece 150 to be machined, and the wire is melted to form a molten pool. In the additive process, the bottom ultrasonic device 130 arranged below the workpiece 150 performs ultrasonic impact on the molten wire on the workpiece 150. The impact of ultrasounds will stir the molten pool, thereby eliminating bubbles in the molten pool. In addition, the ultrasonic bypass device 120 is configured for emitting ultrasonic waves to a melting point of the wire, that is, below the additive welding gun 110, and regulating the droplet transfer of the wire to ensure the stability in the additive welding process, thereby improving the additive efficiency and additive quality. In addition, part of the ultrasonic waves emitted by the bypass ultrasonic device 120 enters the molten pool and the bypass ultrasonic device cooperates with the bottom ultrasonic device 130 to optimize the workpiece 150 in the additive process, thereby eliminating bubbles in the molten pool. Moreover, large grains in the solidification process of the molten pool are broken, and the weld grains are continuously refined, thereby improving the mechanical properties of a weld and enhancing the quality of the workpiece 150.

It should be noted that the molten pool refers to the part that is melted into a pool shape due to the heat of the welding arc generated by the additive welding gun 110. The liquid metal part with a certain geometric shape formed on the weldment during welding is called the molten pool.

It should be noted that under the heat of the arc generated by the additive welding gun 110, the droplet-like liquid metal formed by melting the end of the wire is called a droplet, and the process of the droplet transferred to the molten pool through the arc space is called droplet transfer.

It could be understood that, referring to FIG. 2, the bypass ultrasonic device 120 includes a bypass ultrasonic generator 121, a first ultrasonic transducer 122, and a second ultrasonic transducer 123. The first ultrasonic transducer 122 and the second ultrasonic transducer 123 are arranged on opposite sides of the additive welding gun 110. A signal transmitting end of the bypass ultrasonic generator 121 is connected to the first ultrasonic transducer 122 and the second ultrasonic transducer 123. The bypass ultrasonic generator 121 is electrically connected to the control device 140.

It should be noted that the ultrasonic generator can convert an electric supply into a high-frequency alternating current signal that matches the ultrasonic transducer, and drive the ultrasonic transducer to work. The bypass ultrasonic generator 121 can control the operation of the first ultrasonic transducer 122 and the second ultrasonic transducer, and the first ultrasonic transducer 122 and the second ultrasonic transducer 123 are connected in parallel. The first ultrasonic transducer 122 and the second ultrasonic transducer 123 have the same working state.

It should be noted that the first ultrasonic transducer 122 and the second ultrasonic transducer 123 are arranged on opposite sides of the additive welding gun 110. Compared with the arrangement of a single ultrasonic transducer, according to the arrangement of two opposite ultrasonic transducers, the ultrasonic waves emitted thereby can reach the melting point of the wire from multiple directions or angles, and the ultrasonic energy is stronger, which is beneficial to the regulation of droplet transfer of the wire.

It should be noted that in order to more accurately regulate the droplet transfer of the wire, the first ultrasonic transducer 122 and the second ultrasonic transducer 123 are symmetrically arranged on both sides of the additive welding gun 110, and the distances, angles, etc. between the ultrasonic transducers and the additive welding gun 110 are the same.

It should be noted that the bypass ultrasonic device 120 drives the first ultrasonic transducer 122 and the second ultrasonic transducer 123 to work through the bypass ultrasonic generator 121, so that the first ultrasonic transducer 122 and the second ultrasonic transducer 123 emits ultrasonic waves to the melting point of the wire to form the ultrasonic field, allowing them to regulate the droplet transfer of the wire, further enhancing the stability in the additive welding process and improving the additive efficiency and additive quality. Moreover, part of the ultrasonic waves emitted by the first ultrasonic transducer 122 and the second ultrasonic transducer 123 will enter the molten pool, and the ultrasonic transducers can cooperate with the bottom ultrasonic device 130 to optimize the workpiece 150 in the additive process. Compared with a single bottom ultrasonic device 130, the bypass ultrasonic device 120 and the bottom ultrasonic device 130 cooperate to expedite elimination of bubbles in the molten pool, which reduces the time of additive welding, and further improves the additive efficiency.

It can be understood that, referring to FIG. 2, the bypass ultrasonic device 120 further includes a first amplitude transformer 124 and a second amplitude transformer 125. A receiving end of the first amplitude transformer 124 is connected to a transmitting end of the first ultrasonic transducer 122. A receiving end of the second amplitude transformer 125 is connected to a transmitting end of the second ultrasonic transducer 123. Transmitting ends of the first amplitude transformer 124 and the second amplitude transformer 125 are both concave arc surfaces.

It should be noted that the arrangement of the amplitude transformers is conducive to the gathering and emission of ultrasonic energy of the ultrasonic waves emitted by the ultrasonic transducers, and the transmitting ends of the amplitude transformers are concave arc surfaces, which is more conducive to the gathering and emission of ultrasonic energy.

It should be noted that the ultrasonic waves emitted by the first ultrasonic transducer 122 are gathered by the first amplitude transformer 124 and emitted to the melting point of the wire, and the ultrasonic waves emitted by the second ultrasonic transducer are gathered by the second amplitude transformers 125 and emitted to the melting point of the wire, so that the ultrasonic field formed thereby is further enhanced, allowing them to regulate the droplet transfer of the wire, further enhancing the stability in the additive welding process, and improving the additive efficiency and additive quality.

It could be understood that the first ultrasonic transducer 122 and the second ultrasonic transducer 123 are both fixedly connected to the additive welding gun 110 for the workpiece 150.

It should be noted that the first ultrasonic transducer 122 and the second ultrasonic transducer 123 are both fixedly connected to the additive welding gun 110 for the workpiece 150, so that relative positions between the first ultrasonic transducer 122 and the second ultrasonic transducer 123 and the additive welding gun 110 remain unchanged.

It should be noted that the first ultrasonic transducer 122 and the second ultrasonic transducer 123 for the workpiece 150 are both fixedly connected to the additive welding gun 110 for the workpiece 150, so that parameters of the ultrasonic waves emitted by the bypass ultrasonic device 120 at the melting position of the wire remain unchanged, ensuring the stability of the additive welding process, which is conducive to improving the quality of the workpiece 150.

It could be understood that, referring to FIG. 2, the bottom ultrasonic device 130 includes a bottom ultrasonic generator 131 and at least one third ultrasonic transducer 132. The third ultrasonic transducer 132 is arranged below the workpiece 150 and generates an ultrasonic field covering the workpiece 150. A signal transmitting end of the bottom ultrasonic generator 131 is connected to the third ultrasonic transducer 132. The bottom ultrasonic generator 131 is electrically connected to the control device 140.

It should be noted that at least one third ultrasonic transducer 132 is provided. In practical applications, the workpiece 150 is usually placed on a substrate 154, and the additive welding process is also performed on the substrate 154. The number of the third ultrasonic transducers 132 may be set according to the length of the substrate 154, which is not limited in the embodiments of the present disclosure.

It should be noted that many products require the welding gun to move back and forth to meet their required heights, so that the entire workpiece 150 is located within the ultrasonic field generated by the third ultrasonic transducer, but in case of a plurality of third ultrasonic transducers 132, only the third transducer 132 corresponding to the current melting point of the workpiece 150 may be turned on.

It should be noted that the bottom ultrasonic device 130 drives, through the bottom ultrasonic generator 131, the third ultrasonic transducer 132 to work, so that the third ultrasonic transducer 132 emits ultrasonic waves to perform ultrasonic impact on the workpiece 150. The impact of ultrasounds will stir the molten pool to eliminate bubbles in the molten pool. Moreover, large grains in the solidification process of the molten pool are broken and the weld grains are continuously refined, thereby improving the mechanical properties of the weld, and enhancing the quality of the workpiece 150. Compared with the single bypass ultrasonic device 120, the bottom ultrasonic device 130 has an enhanced stirring effect on the molten pool, making it easier to eliminate the bubbles in the molten pool and break the large grains in the solidification process of the molten pool, further enhancing the quality of the workpiece 150.

It could be understood that, referring to FIG. 2, the arc additive apparatus 100 provided in an embodiment of the present disclosure further includes a welding machine 151 and a wire feeder 152. One end of the wire feeder 152 is connected to the additive welding gun 110 through a pipeline. The wire feeder 152 is configured for transferring the wire to the additive welding gun 110 through the pipeline. The wire feeder 152 is connected to the welding machine 151, and the welding machine 151 is electrically connected to the control device 140.

It should be noted that the wire feeder 152 and the additive welding gun 110 can be connected through the pipeline, and the wire fed by the wire feeder 152 can be accurately transferred below the additive welding gun 110 through the pipeline, so as to facilitate later additive welding. The welding machine 151 mainly controls the waveform of the arc current generated by the additive welding gun 110, and can adjust the peak value of the arc current (the current when the arc current is at its maximum), pulse frequency, peak time, and base current. In addition, the welding machine 151 is further connected to the wire feeder 152, so that the speed at which the wire feeder 152 transmits the wire can be adjusted.

It could be understood that, referring to FIG. 2, the arc additive apparatus 100 provided in an embodiment of the present disclosure further includes a containing device 153 for providing inert gas. The containing device 153 is in communication with the additive welding gun 110.

It should be noted that the containing device 153 and the additive welding gun 110 may be connected through a gas pipeline. Before the additive welding gun 110 is operated, the containing device 153 is opened and the inert gas in the containing device 153 is transferred to the additive welding gun 110, making the inert gas coat the wire, melted liquid droplets and the molten pool. The continuous delivery of shielding gas from the beginning of welding can reduce the probability of oxidation when the molten pool is cooled, and reduce the probability of structural deterioration and mechanical property degradation.

It should be noted that the containing device 153 may be a gas cylinder.

It could be understood that a frequency range of the ultrasonic waves emitted by the bypass ultrasonic device 120 is 20 kilohertz to 50 kilohertz, and a frequency range of ultrasonic waves emitted by the bottom ultrasonic device 130 is 18 kilohertz to 23 kilohertz.

The arc additive apparatus 100 provided in the embodiments of the present disclosure includes an additive welding gun 110, a bypass ultrasonic device 120, a bottom ultrasonic device, and a control device 140. Before the additive welding gun 110 is operated, the containing device 153 is opened, so that the inert gas in the containing device 153 is transferred to the additive welding gun 110, and the welding machine 151 controls the wire feeder 152 to transfer the wire below the additive welding gun 110. The additive welding gun 110 works to melt the wire to add material to the workpiece 150 to be machined. In the additive process, the bottom ultrasonic device 130 drives the third ultrasonic transducer 132 to work through the bottom ultrasonic generator 131, so that the third ultrasonic transducer 132 emits ultrasonic waves to perform ultrasonic impact on the molten wire on the workpiece 150. The impact of ultrasounds will stir the molten pool, thereby eliminating bubbles in the molten pool. Moreover, large grains in the solidification process of the molten pool will be broken and the weld grains are continuously refined, thereby improving the mechanical properties of the weld, and enhancing the quality of the workpiece 150. The bypass ultrasonic device 120 drives the first ultrasonic transducer 122 and the second ultrasonic transducer 123 to work through the bypass ultrasonic generator 121, so that the first ultrasonic transducer 122 and the second ultrasonic transducer 123 emit ultrasonic waves below the material welding gun 110 to form an ultrasonic field, that is, at the melting point of the wire, so that it can regulate the droplet transfer of the wire, thereby further enhancing the stability in the additive welding process and improving the additive efficiency and additive quality. Furthermore, part of the ultrasonic waves emitted by the first ultrasonic transducer 122 and the second ultrasonic transducer 123 will enter the molten pool and the ultrasonic transducers can cooperate with the bottom ultrasonic device 130 to optimize the workpiece 150 in the additive process, thereby improving the mechanical properties of the weld, and enhancing the quality of the workpiece 150.

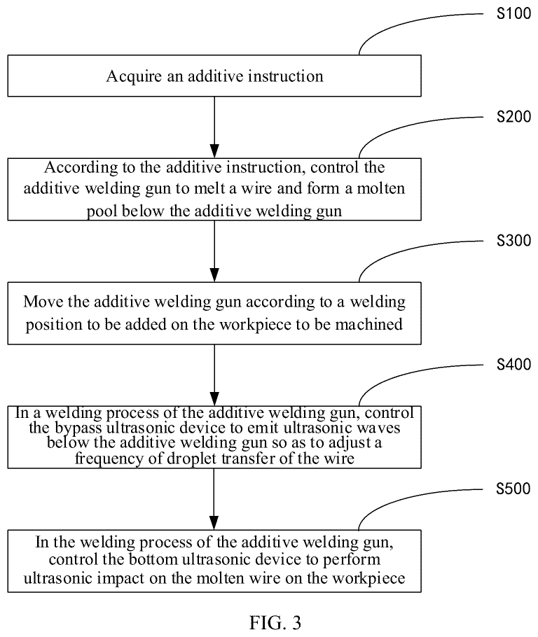

An embodiment of the present disclosure further provides an arc additive method. The arc additive method is applied to the arc additive apparatus 100. The arc additive apparatus 100 includes an additive welding gun 110, a bypass ultrasonic device 120, and a bottom ultrasonic device 130. The bypass ultrasonic device 120 is arranged at a side of the additive welding gun 110, and the bottom ultrasonic device 130 is arranged below the workpiece 150. Referring to FIG. 3, the arc additive method provided in an embodiment of the present disclosure includes, but is not limited to, the following steps.

At S100, an additive instruction is acquired.

It should be noted that the additive instruction comes from settings of the control device 140 in the arc additive apparatus 100 and may be set manually.

It should be noted that the additive instruction correspond to a respective workpiece 150. Different workpieces 150 require different parameters of the arc additive apparatus 100, and their corresponding additive instructions are different.

At S200, according to the additive instruction, the additive welding gun 110 is controlled to melt a wire and form a molten pool below the additive welding gun 110.

At S300, the additive welding gun 110 moves according to a welding position to be added on the workpiece 150 to be machined.

It should be noted that, referring to FIG. 2, the additive welding gun 110 moves according to the welding position to be added on the workpiece 150 to be machined. The moving direction of the additive welding gun 110 is not limited. The additive welding gun 110 moves according to the shape of the workpiece 150, which can meet the requirements on the height of the workpiece 150, and can also meet the requirements of the workpiece 150 in other directions first. Accordingly, for the same workpiece 150, the additive welding gun 110 has various moving directions and moving paths.

At, S400, in a welding process of the additive welding gun 110, the bypass ultrasonic device 120 is controlled to emit ultrasonic waves below the additive welding gun 110 so as to adjust a frequency of droplet transfer of the wire.

It could be understood that the bypass ultrasonic device 120 includes a bypass ultrasonic generator 121, a first ultrasonic transducer 122, and a second ultrasonic transducer 123. The first ultrasonic transducer 122 and the second ultrasonic transducer 123 are arranged on opposite sides of the additive welding gun 110 to enhance the ultrasonic field at the droplet transfer point. A signal transmitting end of the bypass ultrasonic generator 121 is connected to the first ultrasonic transducer 122 and the second ultrasonic transducer 123. The bypass ultrasonic generator 121 is connected to the control device 140.

It should be noted that, according to the melting process of the wire, the bypass ultrasonic generator 121 is controlled to drive the first ultrasonic transducer 122 and the second ultrasonic transducer 123 to emit ultrasonic waves to the melting point of the wire. Such arrangement enables the first ultrasonic transducer 122 and the second ultrasonic transducer 123 to emit ultrasonic waves to the melting point of the wire to form the ultrasonic field, allowing them to regulate the droplet transfer of the wire, further enhancing the stability in the additive welding process and improving the additive efficiency and additive quality. Furthermore, part of the ultrasonic waves emitted by the first ultrasonic transducer 122 and the second ultrasonic transducer 123 will enter the molten pool, and the ultrasonic transducers can cooperate with the bottom ultrasonic device 130 to optimize the workpiece 150 in the additive process.

It should be noted that according to the melting process of the wire, a frequency range of the ultrasonic waves emitted by the bypass ultrasonic device 120 is 20 kilohertz to 50 kilohertz.

At S500, in the welding process of the additive welding gun 110, the bottom ultrasonic device 130 is controlled to perform ultrasonic impact on the melted wire on the workpiece 150.

It could be understood that the bottom ultrasonic device 130 includes a bottom ultrasonic generator 131 and at least one third ultrasonic transducer 132. The third ultrasonic transducer 132 is arranged below the workpiece 150, and the workpiece 150 is located in the ultrasonic field generated by the third ultrasonic transducer. A signal transmitting end of the bottom ultrasonic generator 131 is connected to the third ultrasonic transducer 132. The bottom ultrasonic generator 131 is connected to the control device 140.

It should be noted that according to the current position of the additive welding gun 110, the bottom ultrasonic generator 131 is controlled to drive the third ultrasonic transducer 132 to perform ultrasonic impact on the workpiece 150. Such arrangement enables the third ultrasonic transducer 132 to emit ultrasonic waves to perform ultrasonic impact on the workpiece 150. The impact of ultrasounds will stir the molten pool, thereby eliminating bubbles in the molten pool. Moreover, large grains in the solidification process of the molten pool will be broken and the weld grains are continuously refined, thereby improving the mechanical properties of the weld and enhancing the quality of the workpiece 150.

It should be noted that according to the current position of the additive welding gun 110, the frequency range of ultrasonic waves emitted by the bottom ultrasonic device 130 is 18 kilohertz to 23 kilohertz.

It could be understood that the arc additive apparatus 100 further includes a welding machine 151 and a wire feeder 152. The arc additive method provided in an embodiment of the present disclosure further includes controlling the welding machine 151 to drive the wire feeder 152 to transfer the wire below the additive welding gun 110.

It could be understood that the arc additive apparatus 100 further includes a containing device 153, and then between step S100 and step S200, the arc additive method provided in the embodiment of the present disclosure further includes controlling the inert gas in the containing device 153 to be transferred to the additive welding gun 110.

The arc additive method provided in an embodiment of the present disclosure uses the additive instruction to control the operation of the additive welding gun 110, the bypass ultrasonic device 120, and the second ultrasonic device. The bottom ultrasonic device 130 performs ultrasonic impact on the workpiece 150. The impact of ultrasounds will stir the molten pool to eliminate bubbles in the molten pool. In addition, the bypass ultrasonic device 120 emits ultrasonic waves to the melting point of the wire and regulates the droplet transfer of the wire to ensure stability in the additive welding process, thereby improving the additive efficiency and additive quality. Moreover, part of the ultrasonic waves emitted by the bypass ultrasonic device 120 enters the molten pool, and the bypass ultrasonic device cooperates with the bottom ultrasonic device 130 to optimize the workpiece 150 in the additive process, thereby eliminating the bubbles in the molten pool. Moreover, large grains in the solidification process of the molten pool will be broken and the weld grains are continuously refined, thereby improving the mechanical properties of the weld and enhancing the quality of the workpiece 150. According to the working state of the additive welding gun 110, the bypass ultrasonic device 120 and the bottom ultrasonic device 130 perform auxiliary optimization to generate the workpiece 150, and the quality of the workpiece 150 is significantly enhanced under the action of ultrasounds.

An embodiment of the present disclosure further provides an electronic device, including a memory, a processor, and a computer program stored in the memory and executable on the processor. When executing the computer program, the processor implements the arc additive method from step S100 to step S500.

The processor and memory may be connected via a bus or by other means.

As a non-transitory computer-readable storage medium, the memory may be used to store non-transitory software programs and non-transitory computer executable programs. In addition, the memory may include a high-speed random access memory, and may further include a non-transitory memory, such as at least one magnetic disk storage device, a flash memory device, or other non-transitory solid-state storage device. In some implementations, the memory optionally includes memories located remotely from the processor, and these remote memories may be connected to the processor via networks. Examples of the above networks include, but are not limited to, the Internet, an intranet, a local area network, a mobile communication network and a combination thereof.

The non-transitory software programs and instructions required to implement the arc additive method in the above embodiment are stored in the memory. When executed by the processor, the arc additive method in the above embodiment is executed, for example, S100 to S500 in the above described method in FIG. 3 are executed.

The device embodiments described above are only illustrative, and the units described as separate components may or may not be physically separated, that is, they may be located in one place, or may be distributed to multiple network units. Some or all of the modules can be selected according to actual needs to achieve the purpose of the solution of this embodiment.

In addition, an embodiment of the present disclosure further provides a computer-readable storage medium, which stores computer-executable instructions therein. When executed by a processor or a controller, the computer-executable instructions may enable the above processor to execute the arc additive method in the above embodiment, for example, execute steps S100 to S500 in the above described method in FIG. 3.

Those of ordinary skill in the art may understand that all or some steps and systems in the methods disclosed above can be implemented as software, firmware, hardware, and appropriate combinations thereof. Some or all of the physical components may be implemented as software executed by a processor, such as a central processing unit, a digital signal processor, or a microprocessor, or as hardware, or as an integrated circuit, such as an application specific integrated circuit. Such software may be distributed on computer-readable media, which may include computer storage media (or non-transitory media) and communication media (or transitory media). As is known to those of ordinary skills in the art, the term ‘computer storage media’ include volatile and nonvolatile and removable and non-removable media implemented in any method or technology for storage of information (such as computer readable instructions, data structures, program modules or other data). Computer storage media include, but are not limited to, an RAM, an ROM, an EEPROM, a flash memory or another memory technology, a CD-ROM, a Digital Versatile Disk (DVD) or another optical disk storage, a magnetic cassette, a tape, a disk storage or another magnetic storage device, or any other medium used to store the desired information and that can be accessed by a computer. Additionally, it is known to those of ordinary skills in the art that communication media typically embodies computer readable instructions, data structures, program modules or other data in a modulated data signal such as a carrier wave or another transport mechanism, and may include any information delivery media.

Although the embodiments of the present disclosure have been shown and described, those of ordinary skills in the art will understand that various changes, modifications, substitutions and variations can be made to these embodiments without departing from the principles and purposes of the present disclosure, and the scope of the present disclosure is defined by the claims and their equivalents.

1. An arc additive apparatus, comprising:
an additive welding gun, configured for melting a wire to perform additive manufacturing on a workpiece to be machined;
a bypass ultrasonic device, arranged at a side of the additive welding gun;
a bottom ultrasonic device, arranged below the workpiece; and
a control device, configured for controlling the bypass ultrasonic device to emit ultrasonic waves below the additive welding gun so as to adjust a frequency of droplet transfer of the wire and controlling the bottom ultrasonic device to perform ultrasonic impact on the molten wire on the workpiece.

2. The arc additive apparatus according to claim 1, wherein the bypass ultrasonic device comprises a bypass ultrasonic generator, a first ultrasonic transducer, and a second ultrasonic transducer, the first ultrasonic the transducer and the second ultrasonic transducer are arranged on opposite sides of the additive welding gun, a signal transmitting end of the bypass ultrasonic generator is connected to the first ultrasonic transducer and the second ultrasonic transducer, and the bypass ultrasonic generator is electrically connected to the control device.

3. The arc additive apparatus according to claim 2, wherein the bypass ultrasonic device further comprises a first amplitude transformer and a second amplitude transformer, a receiving end of the first amplitude transformer is connected to a transmitting end of the first ultrasonic transducer, a receiving end of the second amplitude transformer is connected to a transmitting end of the second ultrasonic transducer, and the first amplitude transformer and the second amplitude transformer are both concave arc surfaces.

4. The arc additive apparatus according to claim 2, wherein the first ultrasonic transducer and the second ultrasonic transducer are both fixedly connected to the additive welding gun.

5. The arc additive apparatus according to claim 1, wherein the bottom ultrasonic device comprises a bottom ultrasonic generator and at least one third ultrasonic transducer, the third ultrasonic transducer is arranged below the workpiece and configured for generating an ultrasonic field covering the workpiece, a signal transmitting end of the bottom ultrasonic generator is connected to the third ultrasonic transducer, and the bottom ultrasonic generator is electrically connected to the control device.

6. The arc additive apparatus according to claim 1, further comprising a welding machine and a wire feeder, one end of the wire feeder is connected to the additive welding gun through a pipeline, the wire feeder is configured for transferring the wire to the additive welding gun through the pipeline, the wire feeder is connected to the welding machine, and the welding machine is electrically connected to the control device.

7. The arc additive apparatus according to claim 1, further comprising a containing device for providing inert gas, wherein the containing device is in communication with the additive welding gun.

8. The arc additive apparatus according to claim 1, wherein a frequency range of the ultrasonic waves emitted by the bypass ultrasonic device is 20 kilohertz to 50 kilohertz, and a frequency range of ultrasonic waves emitted by the bottom ultrasonic device is 18 kilohertz to 23 kilohertz.

9. An arc additive method, applied to an arc additive apparatus, wherein the arc additive apparatus comprises an additive welding gun, a bypass ultrasonic device, and a bottom ultrasonic device, the bypass ultrasonic device is arranged at a side of the additive welding gun, the bottom ultrasonic device is arranged below the workpiece, and the arc additive method comprises:
acquiring an additive instruction;
according to the additive instruction, controlling the additive welding gun to melt a wire and form a molten pool below the additive welding gun;
moving the additive welding gun according to a welding position to be added on the workpiece to be machined;
in a welding process of the additive welding gun, controlling the bypass ultrasonic device to emit ultrasonic waves below the additive welding gun so as to adjust a frequency of droplet transfer of the wire; and
in the welding process of the additive welding gun, controlling the bottom ultrasonic device to perform ultrasonic impact on the molten wire on the workpiece.

10. A non-transitory computer storage medium, comprising computer-executable instructions stored therein, wherein the computer-executable instructions are used to execute the arc additive method according to claim 9.
